(19) United States
(12) Patent Application Publication
(10) Pub. No.: US 2026/0053283 A1
(43) Pub. Date: Feb. 26, 2026

(54) COMPOSITE CONSTRUCTION

(71) Applicant: XEFCO PTY LTD, Eveleigh, New South Wales (AU)

(72) Inventors: Thomas HUSSEY, Drummoyne, New South Wales (AU); Dharshika KONGAHAGE, Horsley, New South Wales (AU); Chih Lung LIN, New Taipei City (TW)

(21) Appl. No.: 19/104,210

(22) PCT Filed: Aug. 18, 2023
(86) PCT No.: PCT/AU2023/050788

§ 371 Date: Feb. 15, 2025

(30) Foreign Application Priority Data
Aug. 19, 2022 (AU) 2022902378

(51) Int. Cl. A47G 9/06; A47G 9/00; B32B 5/02; B32B 27/12; B32B 27/32; B32B 27/36

(52) U.S. Cl. CPC A47G 9/06; B32B 5/022; B32B 5/024; B32B 27/12; B32B 27/32; B32B 27/36; A47G 2009/003; B32B 2255/10; B32B 2255/205; B32B 2307/7376

(57) ABSTRACT

The present disclosure may be directed to a composite construction. The composite construction comprising an upper layer with an upper face fabric and an upper lining. A lower layer with a lower face fabric and a lower lining; and wherein at least one of the upper layer and the lower layer includes a metal layer and a bonding layer fixed to said metal layer.

### TECHNICAL FIELD

The present disclosure relates to a composite construction which may be used for retaining heat. More particularly, the present disclosure may relate to a composite construction suitable for inclusion within an inflatable sleeping pad or inflatable device.

### BACKGROUND

Camping equipment is typically desirable to be lightweight and will likely be transported by foot during a camping trip. Sleeping pads are one item that is typical for inclusion in camping trips and is positioned underneath a sleeping bad, or bedding and functions as a mattress. Camping pads provide support, padding, and some insulation for the user.

Simple and conventional sleeping pads are formed from a closed cell foam which are not inflatable, but are compressible. These foam sleeping pads are generally a fixed size and are elastically deformable, and generally do not provide much support to a user. Foam sleeping pads may also be of a thickness which is in the range of 2-3 cm in thickness, and easily deform under the weight of a user during use.

In contrast, inflatable sleeping pads may be relatively more lightweight, and can be either manually or automatically inflated to provide for a supportive and insulative layer which can function as a supportive mattress for a user. These devices are generally more desirable as they provide support, but are also generally more lightweight than the foam non-inflatable variants.

Some sleeping pads are fitted with reflective layers which may enhance the insulative properties provided by the pad by reflecting thermal energy from the body of a user, or by altering the emissivity of the sleeping pad and retaining the thermal energy closer to the user for a longer period of time.

Some inflatable devices also utilise a filling foam which expands when a valve is opened. These devices can self-inflate when a valve is opened and the foam is allowed to return to a non-compressed state. However, these devices may have limitations in relation to the addition of other insulating layers, such as fibre insulations and radiant barrier layers, within the structure.

The complexity of including further insulative materials within a sleeping pad can increase the weight of sleeping pads which causes a potentially undesirable trade-off. Furthermore, the inclusion of insulative materials, such as reflective layers can be difficult to include within a structure and may introduce bonding difficulties and further construction layers to overcome the inherent difficulties with the inclusion of such materials. For example, known sleeping pad constructions must include bonding layers to allow for the inclusion of said reflective layers. This inherently increases the overall weight of the sleeping pad and increases the construction costs involved with additional materials being required.

Some solutions to include reflective materials may also require complex point welding, or point bonding in combination with aperture arrays formed in the reflective materials through which the bonding materials extend. In this way the overall reflective or emissive properties of the reflective layer are limited at these apertures and bonding locations.

As such, it may be desirable to overcome at least some of the problems associated with the prior art to provide a useful alternative or improved alternative.

Any discussion of the prior art throughout the specification should in no way be considered as an admission that such prior art is widely known or forms part of common general knowledge in the field.

### SUMMARY

### Problems to be Solved

It may be advantageous to provide for a lightweight sleeping pad.

It may be advantageous to provide for a composite construction which can be utilised for insulative purposes.

It may be advantageous to provide for a heat reflective sleeping mattress or sleeping pad.

It may be advantageous to provide for a device which can be used to improve the comfort of a user.

It may be advantageous to provide for a noise reducing composite which may be included within a device.

It may be advantageous to provide for a less complex sleeping pad with respect to the prior art.

It may be advantageous to provide for an optimal positioning of a reflective layer within a composite construction.

It may be advantageous to provide for a thinner construction for a pad.

It may be advantageous to provide for an improved radiant barrier construction which can be used for inflatable devices.

It is an object of the present invention to overcome or ameliorate at least one of the disadvantages of the prior art, or to provide a useful alternative.

### Means for Solving the Problem

A first aspect of the present invention may relate to a composite construction. The composite construction may have an upper layer with an upper face fabric and an upper lining and a lower layer with a lower face fabric and a lower lining. At least one of the upper layer and the lower layer may comprise a metal layer and a bonding layer, which may be fixed to said metal layer.

Preferably, an inflatable sleeping pad may be formed with the composite construction. Preferably, the composite construction may have a baffle disposed between the upper layer and the lower layer. Preferably, the baffle may be formed from a fabric and a bonding layer. Preferably, the fabric may be a non-woven fabric. Preferably, a further baffle may be disposed relatively below the first baffle. Preferably, between the baffle and further baffle a middle layer may be disposed therebetween. Preferably, the middle layer may comprise a metal layer with at least one bonding polymer layer. Preferably, at least one of the upper layer and the lower layer may be formed with a polymer layer between the face fabric and the metal layer. Preferably, the face fabric may be a woven material with a closed-cell membrane. Preferably, the upper layer and the lower layer may define a chamber region which can be configured to inflated and compressed configurations. Preferably, if the metal layer is disposed on the upper layer the metal layer may be disposed to face the lower layer. Preferably, if the metal layer is disposed on the lower layer the metal layer may be disposed to face the upper layer. Preferably, both the upper layer and the lower layer may comprise a respective metal layer. Preferably, the metal layer may be vapour deposited onto a polymer layer and laminated with at least one of the upper face fabric and the lower face fabric.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a sectional view of a prior art sleeping pad construction;

FIG. 2A illustrates the material construction along line 1 of FIG. 1;

FIG. 2B illustrates the material construction along line 2 of FIG. 1;

FIG. 2C illustrates the material construction along line 3 of FIG. 1;

FIG. 3 illustrates a sectional view of an embodiment of a composite construction incorporated within a sleeping pad;

FIG. 4A illustrates an embodiment of the material construction along line 1 of FIG. 3;

FIG. 4B illustrates an embodiment of the material construction along line 2 of FIG. 3;

FIG. 4C illustrates an embodiment of the material construction along line 3 of FIG. 3;

FIG. 5A illustrates an embodiment of another material construction along line 1 of FIG. 3;

FIG. 5B illustrates an embodiment of another material construction along line 2 of FIG. 3; and

FIG. 5C illustrates an embodiment of another material construction along line 3 of FIG. 3.

FIG. 6 illustrates a sectional view of an embodiment of a composite construction incorporated within a sleeping pad;

FIG. 7A illustrates an embodiment of the material construction along line 1 of FIG. 6;

FIG. 7B illustrates an embodiment of the material construction along line 2 of FIG. 6; and

FIG. 7C illustrates an embodiment of the material construction along line 3 of FIG. 6.

### DESCRIPTION OF THE INVENTION

Preferred embodiments of the invention will now be described with reference to the accompanying drawings and non-limiting examples.

The present invention may relate to a composite construction suitable for inflatable pads such as, but not limited to, sleeping pads used for camping. The composite construction may have reflective and emissivity properties adapted to retain heat within a structure, such as that of a sleeping pad.

The sleeping pad may have a plurality of support structures, such as baffles, which can be used to fix the tops side and the bottom side of a sleeping pad together when the sleeping pad is inflated or the support structures can be used to maintain a generally even thickness or desired thickness of the sleeping pad. In some embodiments the thickness of the sleeping pad may be varied by altering the length of the support structures which may impart a desired shape to a sleeping pad which could be utilised for comfort or anatomical support during use. These support structures are preferably disposed within the sleeping pad so as to provide for enhanced comfort in addition to reducing overall weight and volume of the device. Furthermore, as sleeping pads are adapted to support the weight of a user, the inflatable structure can be made from non-rigid materials, which allows the sleeping pad to be rolled up or otherwise deflated to transport more easily. It is preferred that the construction of the presently disclosed invention provides for a structure which can allow a user to be elevated from the ground, while maintaining comfort of the user during use. While a sleeping pad is discussed herein, the construction of the present disclosure may also find use in sound proofing, heat proofing or other building constructions.

In yet another embodiment, the construction is adapted to minimise, or substantially eliminate, the heat transfer from the user through the sleeping pad to the ground. The construction preferably retains heat within the construction for a relatively longer period than constructions without at least one radiant barrier, and also can assist with keeping the user warmer by reflecting or providing a barrier to heat transfer from initially taking place.

It is preferred that the materials used fabricating the outer layers of the device can be used to withstand abrasion, wear, and fluid ingress or fluid transport. This is typically advantageous due to the potentially extreme conditions the device is to be used, such as for camping, while also allowing for a reduction of discomfort when a user is laying on the construction. An internal chamber is provided which can be filled with fluids or foam to allow for inflation of the device.

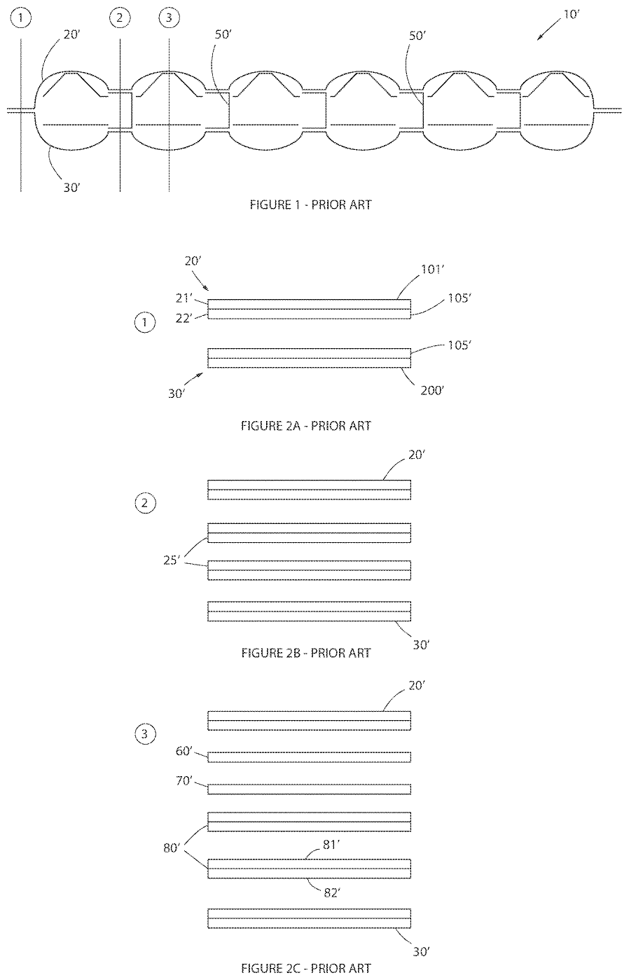

Referring to FIG. 1, there is illustrated an embodiment of a sleeping pad of the prior art. The constructions at locations of the sleeping pad are shown in FIGS. 2A to 2C. The sleeping pad of FIG. 1 is illustrative only and is not to scale or representative of typical thickness to length ratios.

The sleeping pad 10′ shown includes a multi-layer construction with a plurality of bonding locations and tacking points. These tacking points and bonding locations are typically required to be made in very specific regions as material must be removed from some layers to allow for successful and durable bonding between layers of the device.

An outer fabric with a TPU lining or layer 105′ is disposed at the upper side 20′ and lower side 30′ of the construction, and is shown in FIG. 2A, and has an upper fabric 101′ and a lower fabric 200′. The fabric may be any desired fabric which has been laminated with said TPU layer 105′. The TPU layer 105′ is needed to prevent the escape of air from the inside of the sleeping pad and is laminated to the outer fabric with the use of a conventional glue or adhesive known in the art. While TPU may provide a desired barrier, bonding to TPU is less than ideal with respect to bonding of TPU and aluminium and/or PET layers which may be adjacent in a construction. As such, the use of TPU proses difficulties when bonding to these types of materials.

Referring to FIG. 2B there is shown another prior art construction embodiment along line 2 of FIG. 1, which is a baffle connection. Baffle connections 25′ are used inside the structure to impart a desired shape to the sleeping pad 10′ and are used to fix the upper 20′ and lower 30′. The baffle may be formed from the same material as that of the upper side 20′ and or the lower side 30′ and may include a fabric 21′ and a TPU layer 22′ which is adapted to bond to the upper side 20′ at one end and the lower side 30′ at the other respective end of the baffle 25′.

A first reflective layer is tacked onto the upper side 20′ (see FIG. 2C) so as to support the reflective layer in an approximate position. This position will vary with the tacking or bonding method used, and will result in variability of the reflective layer position. Further, the layer to which the reflective materials are bonded to are typically durable, however this durability often results in stiffness of the reflective layer. This stiffness also results in an undesirable crinkle or noise to be made, which is particularly evident for a user when being used for sleeping pad constructions.

FIG. 2C illustrates a sectional view along the line 3 of FIG. 1. The construction includes an upper layer 20′ and a lower layer 30′. The upper layer 20′ comprises a fabric with a first TPU layer affixed thereto. Connected to the first TPU is a bonded scrim layer 60′. A second TPU layer 70′ is disposed below the scrim, which is required to allow for bonding between the layers. A Mylar® layer 80′, otherwise more generically known as a polyester film 82′ which may or may not include a reflective metal coating 81′, is tacked to the second TPU layer.

The TPU layers 105′ are required to be adjacently disposed so as to allow for a point bond that can withstand typical use of the sleeping pad device. The bonding of the upper and the lower TPU layers 105′ may be facilitated by an ultrasonic weld or similar conventional process. The inclusion of TPU layers within the structure is essential as the aluminium and PET layers are not able to bond effectively without this material. In this way, the potential structures of the prior art are limited in nature.

Tacking the Mylar® layer 80′ to the second TPU allows the Mylar® layer to be elevated as bonding of the Mylar® layer 80′ cannot be achieved otherwise. Furthermore, the Mylar® layer 80′ must be modified with this configuration such that an aperture array is cut through the layer 80′ to allow for baffle placement and bonding. As can be seen in FIG. 1, the layers 80′ are not continuous, and additional modifications and difficult constructions methods are required to be employed for correct placement of the Mylar® within the construction. The lower Mylar® layer 80′ is typically not bonded or tacked to the upper or lower of the construction, and is bound in place by the baffles, but can travel up and down the baffles 25′ due to the apertures formed within the Mylar® layer 80′.

An aperture array must be disposed within the Mylar® 80′ to allow the baffles 25′ to be put into position, as can be seen by the non-continuous layer of Mylar® in FIG. 1. This is not desirable as the properties of the Mylar® layer 80′ is weakened and increases the potential for tearing. The Mylar layer 80′ may be formed as a two layered structure including a PET/Mylar® substrate with a metal coating thereon. Further, the apertures in the mylar are generally required to be larger than the point bonds or welds required to connect the baffles. In this way the reflective and emissivity benefits of including the Mylar® is limited to achieve the baffle bonding. In addition, the baffle 25′ bonding with the TPU is also of a strength which is less than desirable.

The configurations of the sleeping pad seen in FIGS. 1, 2A, 2B and 2C are exemplary of the state of the art. There are a number of inherent design complexities, and further there are a number of processes and different unique substrates which are required to form such a construction. It would therefore be advantageous to utilise the present disclosure to provide for an alternative that may provide a benefit, in terms of at least one of; cost, material consumption, construction complexity, improvement of reflectivity, improvement of emissivity, improved layer placement, thermal retention, weight reduction, or any combination thereof.

Referring to FIG. 3, there is illustrated an embodiment of a device 10. The device 10 comprises a plurality of layers configured so as to form a composite construction. The composite construction is shown as having an upper layer 20, a lower layer 30, a chamber 40 formed between the upper layer 20 and the lower layer 30. A plurality of pockets or sections 45 form part of the chamber 40. A plurality of baffles 50 are shown as being disposed between the upper and the lower layers 20, 30. The baffles 50 may have at least one channel formed therein (not shown) and allow for fluid movement between adjacent pockets 45 of the chamber 40.

In one embodiment, the upper layer 20 can be formed with a face fabric 21, a non-porous polymer layer 22, a metallic layer 23, and a bonding polymer layer 24. While this configuration is advantageous, the combination of these layers is challenging as fixation of a bonding polymer with a metallic layer 23 (or metal layer 23) is difficult to achieve. The metallic layer or metal layer may be applied with a physical vapour deposition (PVD) and/or chemical vapour deposition (CVD) process. Notably, bonding strength between the deposition and the treated layer may be improved with the use of a plasma treatment and/or a corona treatment.

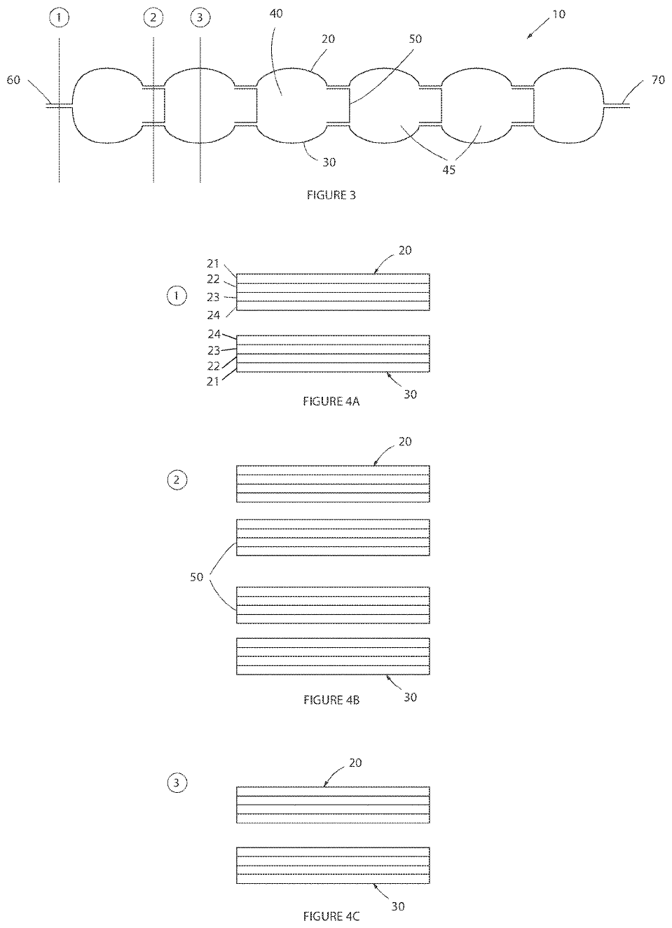

Preferably, the upper layer 20 and/or lower layer 30 with the metallic layer are continuous when positioned within the construction. Continuous layers have less than around 10% of their overall surface area cut out or covered to accommodate baffles within a construction, such as when used in a sleeping pad. The layers 20, 30 may be mirrored in their construction or position. For example, in the construction of the embodiment of FIG. 4 the layers 20, 30 maybe mirrored such that the face fabric is the outer-most layer of each other upper layer and the lower layer 30. In other embodiments, the construction may be mirrored at the midpoint between the upper layer 20, and the lower layer 30. For example, any of embodiments 3 to 7C of this disclosure may optionally be mirrored at the midpoint of the construction such that the layers may be a reflection around the midpoint.

The metallic layer 23 may be formed from at least one of the following materials; A list of suitable PVD source materials may include at least one of the following: Aluminum, Aluminum Copper, Aluminum Copper Tungsten, Aluminum Nitride, Aluminum Oxide, Aluminum Silicon, Antimony, Barium, Barium Ferrite, Barium Fluoride, Barium Strontium Titanate, Barium Titanate, Barium Oxide, Beryllium, Bismuth, Bismuth Lanthanum Titanium, Bismuth Strontium Calcium, Bismuth Strontium Titanate, Bismuth Titanium Oxide, Bismuth Trioxide, Boron, Boron Carbide, Boron Nitride, Cadmium Fluoride, Cadmium Oxide, Cadmium Selenide, Cadmium Sulfide, Cadmium Telluride, Calcium Fluoride, Calcium Oxide, Calcium Silicate, Calcium Titanate, Carbon (Graphite), Carbon Steel, Cerium, Cerium Oxide, Chromium, Chromium Boride, Chromium Oxide, Chromium Silicide, Cobalt, Cobalt Chromium, Cobalt Oxide, Cobalt Silicide, Cobalt Zirconium, Copper, Copper Sulfide, Copper Oxide, Dysprosium, Erbium, Europium, Gallium, Gallium Arsenide, Gallium Oxide, Gadolinium, Germanium, Germanium Nitride, Germanium Oxide, Gold, Gold Germanium, Gold Palladium, Gold Tin, Gold Zinc, Hafnium, Hafnium Carbide, Hafnium Nitride, Hafnium Oxide, Holmium, Inconel, Indium, Indium Oxide, Indium Tin Oxide, Iridium, Iron, Iron Oxide, Lead, Lanthanum, Lanthanum Aluminate, Lanthanum Boride, Lanthanum Oxide, Lanthanum Strontium Cobalt Oxide, Lanthanum Manganese Oxide, Lead Oxide, Lead Titanate, Lead Zirconium Titanate Oxide, Lithium, Lithium Carbonate, Lithium Cobalt Oxide, Lithium Niobate, Lithium Phosphate, Lithium Tantalate, Magnesium, Magnesium Fluoride, Magnesium Monoxide, Magnesium Oxide, Manganese, Molybdenum, Molybdenum Oxide, Molybdenum Selenide, Molybdenum Silicide, Neodymium, Neodymium Gallium Oxide, Neodymium Iron Boride, Nickel, Nickel Chromium, Nickel Cobalt, Nickel Oxide, Nickel Silicide, Nickel Vanadium, Niobium, Niobium Oxide, Palladium, Platinum, Praseodymium, Rhenium, Rhodium, Ruthenium, Samarium, Samarium Cobalt, Scandium, Scandium Oxide, Selenium, Silicon, Silicon Carbide, Silicon Dioxide, Silicon Monoxide, Silicon Nitride, Silver, Silver Oxide, Strontium Bismuth Niobium Oxide, Strontium Bismuth Tantalum Niobium, Strontium-doped Lanthanum, Strontium Oxide, Strontium Titanate, Tantalum, Tantalum Carbide, Tantalum Nitride, Tantalum Oxide, Tantalum Silicide, Tantalum Sulfide, Tellurium, Terbium, Terbium Iron, Thallium, Thallium Oxide, Thorium Fluoride, Thorium Oxide, Tin, Tin Oxide, Titanium, Titanium Boride, Titanium Carbide, Titanium Nitride, Titanium Oxide, Titanium Silicide, Titanium Sulfide, Tungsten, Tungsten Silicide, Tungsten Sulfide, Tungsten Titanium, Vanadium, Vanadium Pent Oxide, Yttrium, Yttrium Barium Copper Oxide, Yttrium Oxide, Zinc, Zinc Oxide, Zinc Selenide, Zinc Sulfide, Zirconium, Zirconium Nitride, Zirconium Oxide, Zirconium Silicate, Zirconium Oxide Yttrium Oxide.

It will be appreciated that the metallic layer 23 is preferably reflective to improve the heat reflectance inside the construction, however the metallic layer 23 may also preferrable have a low emissivity to reduce the emission of heat from a radiant barrier, and/or may also be suitable for reducing the emission of radiant heat from a radiant source. In this way the metallic layer 23 may function as a radiant barrier, and may be referred to herein as such.

Face fabrics 21 may be any predetermined substrate selected from the following group; nylon, polyamide, rayon, polyester, PP, PET, PE, aramid, acrylic, acrylate, paper, wool, silk, cotton, linen, woven textiles, non-woven textiles, braided textiles, insulation materials, synthetic materials, natural materials, organic materials or any other material which may be used to improve comfort of a user. Optionally, the face fabric may be formed with a foam layer to improve comfort when used as a sleeping pad. The face fabric 21 may be a porous layer, and may be adhered or bonded with a non-porous layer 22 which may or may not be a membrane layer. Face fabrics 21 may be selected for comfort, tear resistance, wear resistance or visual aesthetic purposes.

Formation of the upper layer 20 may take several processes including physical vapour deposition or sputtering processes to coat at least one of the non-porous polymer layer 22 and the bonding polymer layer 24.

In one embodiment, the bonding polymer layer may be deposited with a metallic layer 24 which may be a metallic film. The metallic layer or metallic film may be in the range of 10 nm to 500 nm thick. To deposit the metallic layer a corona treatment or a plasma treatment may be used to assist with bonding between the metallic and the bonding polymer layer such that the metallic layer remains fixed with the bonding polymer layer. Such plasma treatments may be performed in a vacuum chamber or in atmospheric conditions. Without sufficient fixation, the metallic layer may be removed from the bonding polymer layer and the construction will fail.

Materials for the bonding polymer layer may be selected from at least one of the following: linear low-density polyethylene (LLDPE), low-density polyethylene (LDPE), medium-density polyethylene (MDPE), high-density polyethylene (HDPE), polyvinyl-chloride (PVC), ethylene vinyl acetate (EVA), polypropylene (PP), polyethylene based polyolefin elastomers (POE), thermoplastic polyester elastomer (TPC-ET), polypropylene based elastomers (TPE-O), thermoplastic polyurethane elastomer (TPU), polymethyl methacrylate (PMMA), and polyaniline. While the aforementioned list may be used, the primary desired polymers may be LLDPE or LDPE due to their desirable bonding properties and quietness in use.

In another example, the metallic layer 23 is deposited onto a non-porous substrate or layer, such as a polyethylene terephthalate (PET) film or the like. If this is the case, then a bonding polymer layer can be laminated to the metallic layer 23 and the non-porous layer can be laminated to a further layer, which may be a face fabric, or a scrim for example.

Optionally, the non-porous layer 22 is a membrane which can allow for the passage of liquids, but not gases. Other suitable substrates to form layer 22 may include; hydrophobic microporous substrates or hydrophilic non-porous substrates such as polytetrafluoroethylene (PTFE), acrylic or polymethyl methacrylate (PMMA) polycarbonate (PC) polyethylene (PE) polypropylene (PP) polyethylene terephthalate (PETE or PET) polyvinyl chloride (PVC) acrylonitrile-butadiene-styrene (ABS).

One advantage of at least one construction embodiment of the present disclosure is that the baffles 50 can connect with the upper and the lower layers 20, 30 without requiring an aperture to be formed in the reflective layer. Notably, the baffles can be formed with a reflective coating and also bond to the upper 20 and the lower layers 30 which can improve the overall reflective functionality of the construction, and also improve the emissivity of the construction. This may therefore provide for a warmer construction, particularly when used in sleeping pads and the like.

The bonding of the baffles 50 can be facilitated as the bonding polymer layer 24 of the construction can be disposed adjacent to the bonding layer of the upper layer 20 and/or the lower layer 30. This bonding is unique in that the metallic layer 23 of at least one of the upper layer 20, lower layer 30 and the baffle 50 is integrally formed therewith, and a bonding layer is therefore disposed over the metallic layer which allows for bonding.

One primary advantage of utilising LLDPE is that it may be used in hot melt lamination processes whereas conventional TPU cannot. The utilisation of this material may further provide an improvement in relation to allowing for reflection of thermal energy and/or reducing emissivity.

Furthermore, the use of a corona treated LLDPE layer allows for an improved bonding with the metallic layer. Preferably the metallic layer is deposited onto the LLDPE layer after corona treatment. Other atmospheric plasma treatments may also be applied to the LLDPE layer, such as an etching step or an oxygen plasma may be used to activate or clean the surface of the layer. Optionally, an atmospheric plasma coating may be applied to a layer which may be used to improve adhesion by providing a nanometre to micrometre thick chemical coating which may have a desired functionality or surface roughness.

Turning to the embodiment of line 1 of FIG. 3 shown in FIG. 4A, there is illustrated an embodiment wherein the upper 20 and lower 30 layers are bonded together at an interface. The construction of the lower may be a reflection of the upper in that there is a face fabric, a membrane or non-porous layer, a metallic layer, and a bonding layer, in which the bonding layers of the upper 20 and the lower 30 layers are disposed in contact such that bonding between the upper and lower can be effected.

It will be appreciated that bonding or fixation of a single bonding polymer layer directly with the metallic layer of the upper and the metallic layer of the lower can be enacted with the use of a single bonding layer only, and both the upper 20 and lower 30 need not both comprise said bonding polymer layer. Furthermore, only one of the upper and the lower may comprise a metallic layer, or in another embodiment a middle layer 80 may be formed with a metallic layer with both, one or neither of the upper and the lower layers comprising such a layer. Each of the upper, middle and lower layers may have a respective metallic layer, with each metallic layer differing in any desired manner, or formed with the same metallic layer structure. Metallic layers may be altered for specific purposes, cost, reflective properties, conductive properties, emissivity properties, thickness, surface roughness or predetermined patterned array.

FIG. 4B illustrates an embodiment along line 2 of FIG. 3, wherein a baffle 50 is shown extending between the upper layer and the bottom layer. The orientation of the baffle may be such that a reflective surface may be seen on one or two sides of the baffle, and may improve the thermal heat retention within a chamber 40 pocket 45. The baffle 50 may be formed from a similar structure as the upper 20 and/or lower 30 layers. The baffle 50 may have a metallic layer 23 which may be applied to a substrate layer via a PVD method such as sputtering, or evaporation PVD methods. Substrate layers may be any combination face fabric layer 21, non-porous polymeric layer 22, bonding polymer layer 24, or membrane discussed herein. Similarly, baffle 50 may be formed from any combination of face fabric layer 21, non-porous polymeric layer 22, bonding polymer layer 24, or membrane layers discussed herein. It will be appreciated that more than one of the same layer or material may be used in an upper layer 20, lower layer 30, baffle 50,55, or middle layer 80. It will be noted that while both sputtering and evaporation methods are PVD methods, each have distinct advantages and disadvantages, and notable evaporation methods typically cannot be used on woven or non-woven fabrics without significant outgassing causing failure of adhesion. As such, sputtering may be used to provide for a reliable, yet slower method of metal deposition.

It will be appreciated, however, that the present construction may utilise evaporation deposition techniques with additional fabric processing techniques developed by Xefco™ and thereby further improving the industrial applicability with the use of faster processing speeds which also require less strict processing environments during the PVD process. Such advantageous processes are discussed and contained within a number of patent publications in the name of Xefco Pty Ltd.

FIG. 4C illustrates an embodiment of the construction of the section along line 3 seen in FIG. 3. This construction is identical to that of FIG. 4A as the upper layer 20 and the lower layer 30 are continuous along the length of the construction and the metallic layer is integrally formed with these layers, or otherwise laminated thereto. Between the upper layer 20 and the lower layer 30 a chamber is defined which can be filled with a gas, fluid or foam. If a foam is used it is preferred that the foam expands to allow for air gaps to be present adjacent to the metallic layers, or is formed such that passages or gaps are formed in the foam to allow for air pockets in communication with the upper layer 20 and/or lower layer 30 to take advantage of the metallic layer 23 properties as a radiant barrier. Gap may be formed in the foam by removing sections of foam, or undulating or texturing the surface of the foam. More preferably, the chamber does not comprise foam, and is inflated with the use of gases alone. The baffles 50 may be used to define pockets 45 within the chamber 40 and each pocket may have one or more surfaces with a metallic layer positioned to face the middle of its respective pocket. In this way chamber 40 may be formed with one or more pockets 45.

This may allow for multi-walled reflective internal surfaces which may further improve the thermal retention of a construction, which may particularly be useful for sleeping mattresses, sleeping bags, sleeping pads, insulation devices and the like. In one embodiment each of baffle 50 and the upper and lower layers 20, 30 are formed with a reflective metallic layer visible through any bonding polymer layer 24, or any other substrate that makes contact with the metallic layer. Alternatively, the face fabric 21 may have two metallic layers disposed thereon and a bonding polymeric layer 24 disposed on the outer surfaces of the metallic layer 24. It will be appreciated that the face fabric in this embodiment may be porous, such as a woven or non-woven material, and the bonding polymeric layers may also be porous, and therefore any metallic layers 23 deposited to either of these layers 21, 24 may be inherently porous also, and therefore allow for the passage of fluids through baffles 50 and between pockets 45.

In prior art configurations the movement of fluids between areas within a sleeping pad, for example, require the use of apertures or holes to allow for this movement. It will also be appreciated that the baffles of the present disclosure may also allow for predetermined apertures to be formed in the baffles also.

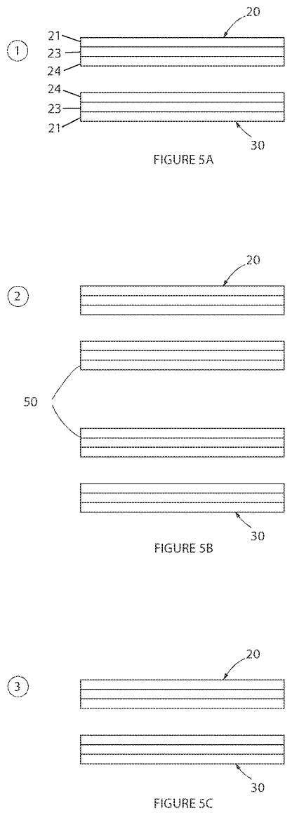

Referring to FIG. 5A to 5C, there are illustrated embodiments of further constructions along lines 1 to 3 as seen in FIG. 3. FIGS. 5A to 5C may be the same as the construction of FIGS. 4A to 4C, respectively, except that the metallic layer 23 of these constructions is not deposited onto, or adjacent to, a non-porous layer, and is instead deposited directly onto a face fabric 21 or a bonding polymeric layer 24. These embodiments do not require the non-porous layer 22 as at least one of the lamination between the aluminium and an adjacent layer 21, 24 provides an airtight barrier, and/or the bonding polymeric layer 24 forms an airtight barrier, and thereby a sealed chamber 40 can be formed. This further reduces the weight of the construction, relative to the construction of FIGS. 4A to 4C, and further reduces the cost of manufacturing as less material is required and fewer lamination or bonding steps are also therefore required.

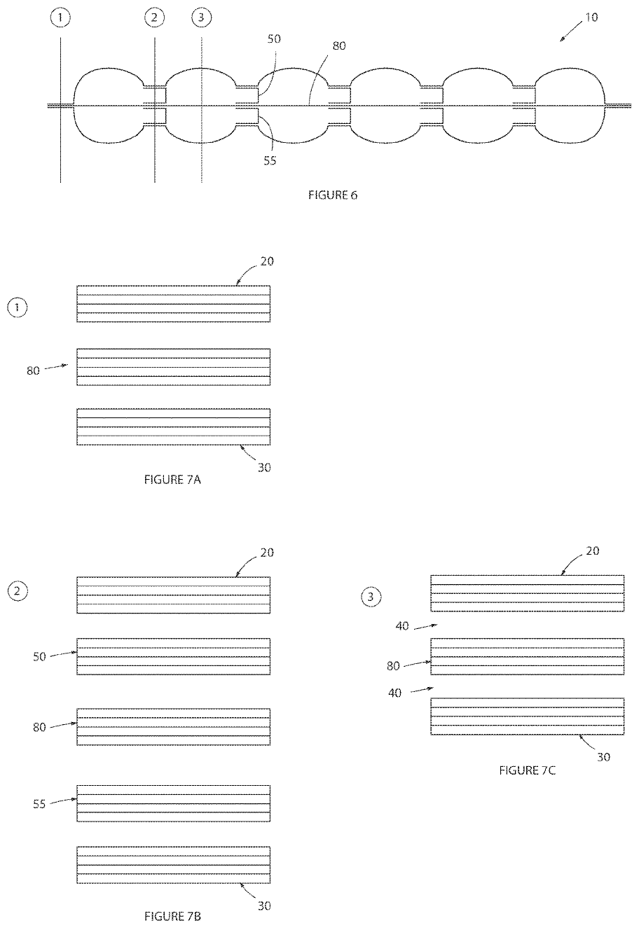

Optionally, while the above embodiments are shown with bonding polymeric layers 24 in communication with other bonding polymeric layers 24, only one bonding polymeric layer 24 may be required for bonding between the baffle 50 and an upper layer 20 or lower layer 30. Similarly, this may also be the case for the embodiments of FIGS. 6 through 7C in which a further middle layer 80 is provided. The layers of the construction may be mirrored such that the upper layer 20 is the same as lower layer 30, in which the lower layer 30 is rotated 180°, or otherwise flipped over, relative to the upper layer 20. In this way a midpoint between all layers of the construction may be defined and layers in the upper region may face a first direction, and the corresponding layers in the lower region 30 may face in a second direction such that the layers could be considered to face towards the midpoint selected. In the embodiment of 7B, the midpoint may be a position in which middle layer 80 defines the midpoint.

Referring to FIG. 6 there is illustrated yet another embodiment of a composite construction for use in a sleeping pad. The construction is similar to that of FIG. 3, but includes an upper baffle and a lower baffle fixed to a middle reflective layer 80.

The upper baffle 50 and the lower baffle 55 may be formed from the same material and may be of identical construction. Optionally, one of the upper 50 and the lower 55 baffles may be longer than the other respective baffle such that the reflective layer 80 can be positioned in a predetermined position within the chamber 40. Allowing for multiple stacked baffles as seen in FIG. 6 can allow for optimal placement of the middle layer within the construction. This cannot be achieved by the prior art as the reflective layers cannot be bonded with the baffles, and are formed with apertures to allow for baffles to pass through the reflective layers. As such, the construction disclosed herein is a significant improvement over the conventional constructions which may be used in sleeping pads.

Optionally, the middle layer may have the metallic layer visible on both the upper side and the lower side. Bonding polymer layers may be disposed on either side of the metallic layer and are preferably transparent to allow for the metallic layer to have a level of reflective capability. Optionally, the metallic layer is deposited onto a non-porous layer or a base layer, similar to that of the upper 20 and the lower 30 layers. A bonding polymer layer can be applied to the non-porous layer and the exposed side of the metallic layer.

FIG. 7A illustrates an embodiment of a construction along line 1 of FIG. 6. The construction from top to bottom includes an upper layer 20, a middle reflective layer 80, and a lower layer 30. The middle layer 80 is disposed and bonded between the upper and the lower layers. Upper layer may be configured similar to that of the upper layer of FIG. 3. Middle layer 80 may be formed with a bonding polymer layer 24 fixed to a non-porous 22 or a porous layer, a metal layer bonded with the non-porous 22 or porous layer (such as a membrane), and a further bonding polymer layer 24 bonded thereto. The orientation of the metal layer in the construction may be in a desired orientation for any embodiment.

While there is illustrated a four-part layer in FIG. 7A for the middle layer 80, said middle layer 80 may be formed as a three part layer in which the metallic layer is deposited onto a bonding polymer layer 24. In this way the overall thickness of the substrate, and weight of the substrate can be reduced. A second bonding polymer layer 24 can be disposed immediately adjacent the metallic layer, and may be glued, welded, laminated or adhered to the exposed side of the metallic layer after deposition. In a construction of layer 80 such as just described, this configuration may be in the order of a bonding layer 24, a metallic layer 23, and a further bonding layer 24. In this way a three-part layer may be formed, in which the layer comprises two bonding polymer layers 24 (a first and a second bonding layer), and a metallic layer therebetween.

It will be appreciated that laminating the bonding polymer layer 24 to the metallic surface may require a plasma treatment or a corona treatment before application of adhesive or before welding. The plasma treatment or corona treatment may apply the adhesive, or active the surface of one of the exposed metallic layer and/or the bonding polymer layer 24 to be stuck/adhered with the exposed metallic surface of layer 80.

It is preferred that the first and second bonding polymer layer 24 are formed with a thickness of between 50 nm to 800 micron, and are preferably formed with a thickness such that the metallic layer is not deformed or melted into the bonding polymer layer 24 after welding or melting of the outer surface of the bonding polymer layer 24. It may also be desirable for the bonding polymer layer 24 to have localised melting or tacking which does not deform surrounding portions of bonding polymer layer 24.

FIG. 7B illustrates an embodiment of the construction which may be present along line 2 of FIG. 6. The construction includes a similar upper, middle and lower layer as seen in FIG. 7A, but further includes two baffles 50, 55, which are bonded to the upper layer 20 and the middle layer 80, and the middle layer 80 and the lower layer 30 respectively. The baffles may be formed from the same material as that of the middle layer, the upper layer and/or the lower layer. In another embodiment, the baffles 50, 55 can be formed from a homogenous material which allows for bonding between the layers 20, 30, 80. While the illustration of FIG. 7B shows baffles 50 and 55 as a single four-layer construction, it will be appreciated that these may have a further four-layer construction immediately adjacent the middle layer 80, in which the baffles are bonded in a C-shape, as seen in FIG. 6, for example.

It will be appreciated that the baffles of at least one embodiment may be formed with a single layer of bonding material, such that a C-shape or O-shape can be formed and still allow for bonding to adjacent layers.

Turning to FIG. 7C there is illustrated an embodiment of the construction which may be seen at line 3 of FIG. 6. The construction is similar to that of the construction at line 1 of FIG. 6. This is due to the advantage of the present configuration allowing for continuous substrates to be used with the construction, which simplifies construction while also providing the benefit of weight reduction and increasing the chamber 40 size in which reflectivity may be achieved compared to known devices.

Allowing for continuous layers to be formed, particularly continuous layers with integral metallic layers 23, allows for a more optimal control over the relative location of the final position of the metallic layers 23 when a construction is filled with air. The location of the metallic layers being at the periphery of the chamber, or pocket of a chamber, allows for optimal baffle spacing with respect to thermal reflectance and emissivity properties of the metallic layer. This may thereby improve the overall thermal efficiency of the construction when compared with the known devices or constructions in the art. Furthermore, having a metallic layer 23 integrally formed with at least one of the baffles 50, 55, upper layer 20, middle layer 80, and lower layer 30 allows for the correct placement of the metallic layer 23 when in use. Notably, metal layers used in the prior art are typically free to move within the chamber of a sleeping pad, or have allowed movement due to tacking locations. This is typically undesirable as metal layers in these configurations can be creased, deformed, not optimally spaced or have their reflective capabilities impeded by such constructions. Therefore, the inclusion of a metallic layer as an integral component of baffles 50, 55, upper layer 20, middle layer 80, and lower layer 30 provides a significant advantage, while also simplifying construction.

Typical valves and pump devices known within the art may be used with any desired embodiment as discussed herein. Furthermore, in at least one embodiment there may be included an expanding foam or similar self-inflation feature. Preferably, the embodiments discussed herein are flexible and allow for rolling or compression to remove air from the construction.

It will be appreciated that any reference to “layers” herein with respect to the inventions may be interchangeable with the term “substrate”. Substrates may be distinct layers which can exist with, or without, an adjacent substrate being required. Each substrate may have its own properties, thicknesses, and materials relative to other substrates in the construction.

Baffle 50 may optionally be formed with any number of bonding layers. Each of the bonding layers may be adapted to be fixed, fused, bonded or adhered to another layer or substrate within the construction.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A composite construction comprising;
an upper layer with an upper face fabric and an upper lining;
a lower layer with a lower face fabric and a lower lining; and
wherein at least one of the upper layer and the lower layer includes a metal layer and a bonding layer fixed to said metal layer.

2. The composite construction as claimed in claim 1, wherein an inflatable sleeping pad is formed with the composite construction.

3. The composite construction as claimed in claim 1, wherein the composite construction has a baffle disposed between the upper layer and the lower layer.

4. The composite construction as claimed in claim 3, wherein the baffle is formed from a fabric and a bonding layer.

5. The composite construction as claimed in claim 4, wherein the fabric is a non-woven fabric.

6. The composite construction as claimed in claim 3, wherein a further baffle is disposed relatively below the first baffle.

7. The composite construction as claimed in claim 6, wherein between the baffle and further baffle a middle layer is disposed therebetween.

8. The composite construction as claimed in claim 7, wherein the middle layer comprises a metal layer with at least one bonding polymer layer.

9. The composite construction as claimed in claim 1, wherein at least one of the upper layer and the lower layer are formed with a polymer layer between the face fabric and the metal layer.

10. The composite construction as claimed in claim 1, wherein the face fabric is a woven material with a closed-cell membrane.

11. The composite construction as claimed in claim 1, wherein the upper layer and the lower layer define a chamber region which can be configured to inflated and compressed configurations.

12. The composite construction as claimed in claim 1, wherein if the metal layer is disposed on the upper layer the metal layer is disposed to face the lower layer.

13. The composite construction as claimed in claim 1, wherein if the metal layer is disposed on the lower layer the metal layer is disposed to face the upper layer.

14. The composite construction as claimed in claim 1, wherein both the upper layer and the lower layer comprise a respective metal layer.

15. The composite construction as claimed in claim 1, wherein the metal layer is vapour deposited onto a polymer layer and laminated with at least one of the upper face fabric and the lower face fabric.
